(19) United States
(12) Patent Application Publication
(10) Pub. No.: US 2008/0250836 A1
(43) Pub. Date: Oct. 16, 2008

(54) Method and Device For Damping a Roll Housing

(76) Inventors: Stephane Gouttebroze, Givors (FR); Yves Leclercq, L'Etang-La-Ville (FR)

Correspondence Address: ARENT FOX LLP, 1050 CONNECTICUT AVENUE, N.W., SUITE 400, WASHINGTON, DC, 20036, US

(21) Appl. No.: 11/579,802

(22) PCT Filed: May 9, 2005
(86) PCT No.: PCT/FR05/01152

§ 371 Date: Nov. 7, 2006

(30) Foreign Application Priority Data
May 7, 2004 (FR) 0405009

(51) Int. Cl. B21B 37/00; F16F 9/44

(52) U.S. Cl. 72/246; 72/234; 188/285; 188/298; 188/313

(57) ABSTRACT

The invention relates to a damping method and device for a roll stand to reduce the sensitivity to chatter thereof. In the method of the invention the absorption is conducted by a chatter mass (8) situated above each post (2) forming the roll stand (1) and the vibration energy is dissipated in a mattress (83) of an incompressible fluid forming a direct link between each post (2) and the chatter mass (8)

According to the invention the fluid mattress is kept in a steady flow by supply means (91) and exhaust means of adjustable caliber (92). The frequency response of the system and its damping coefficient are set by the dimensioning of the chatter mass (8), the control of the thickness (h) of the fluid mattress and its flow rate via the calibrated orifice (92).

The present invention relates to a method and device for damping vibrations in a rolling stand and applies particularly to the rolling of band-type flat products for which the thickness adjustment and the mechanical features are obtained by strain hardening done usually on so-called tandem rolling trains, including several successive stands.

The cold tandem rolling mills comprise a succession of stands arranged after one another on the path of the band whereof they ensure gradual decrease in thickness. Under the action of the significant masses in rotation, such as the work rolls, the back-up rolls, the control reducing gears of the rolling stands, rolling trains are prone to vibrate unduly, in particular at high rolling speed.

Such phenomenon may be compared to a resonance phenomenon since it occurs at a substantially fixed frequency for a determined rolling stand beyond a certain speed threshold. It may cause variations in the thickness, band breakages as well as marks on the work cylinders and on the band.

This phenomenon is hence particularly disturbing for the production since the most obvious remedy to solve this shortcoming consists in reducing the speed.

Although the origin of such vibrations is not yet explained perfectly, several causes seem liable to cause the phenomenon which takes its rise in the interaction between the traction of the band between the stands and the thickness reduction process in the gap between the work cylinders which, taking into account the generated stresses, causes an elastic deformation of the whole rolling stand.

Since the band is held perfectly stretched in the space between two successive stands, the traction between the stands and the stresses for the rolling interact on each other and the traction in the band must be adjusted in each of the inter-stand spaces.

The rolling stands are provided with devices for clamping the cylinders which enable to reduce the thickness of the rolled product and also to adjust the traction between two successive stands by bepping as far as possible, constant rolling conditions in each of the stands, and thereby preventing from reaching traction levels which might lead to a band breakage.

Generally speaking, the regulation of a cold tandem train uses the mass conservation law applied to the band. As the width thereof does not change when passing through a cold rolling stand, this law keeps the metal flow rate which is given by the product of the thickness by the speed. The objective is to obtain a constant thickness at the outlet of the tandem train. To do so the thickness of the band at the outlet of the first stand is kept perfectly constant using the means of clamping of the cylinders of the first stand, as well as the speeds of the first and the last stands by controlling the speeds of the stands.

Thus the upstream and downstream tractions of a roll stand and the rolling strength interact via the metal which flows elasto-plastically in the gap. It is clear that a disturbance affecting the load of the tractions will have an immediate consequence on the thickness. The mechanical assembly thus constituted by the stands of the rolling mill may be excited such that it vibrates by frequencies associated with the rotation of the cylinders and the driving thereof as the rotation frequency of the working cylinders, of the frequencies associated with the gears placed on the reducing gears of the stands, etc.

In certain flow conditions of the metal between the working cylinders and in particular according to the lubrication conditions and according to the roughness of the cylinders, there may be a resonance catching above a certain speed. If no parameters are corrected, the vibration phenomenon is then divergent and it may lead to the breakage of the band. All things considered, the length of the band which has been subjected to vibrations exhibits significant marks and variations in thickness leading to discard this length.

It has therefore been sought to characterise the different resonators which might be involved in the phenomenon so as to calculate its eigen frequencies and to compare it with the frequencies observed on the equipment. The roll stands have hence been subjected to more or less sophisticated modellings. In this view, a stand camber under the rolling strain is usually considered as a global spring effect, by taking into account the masses liable to move, i.e. the roll cylinders and the chocks, the assembly forming a simple spring-mass system whereof one may determine the vibration mode. Such a system is said with one single degree of freedom. One may also consider a certain damping of the system by taking into account the frictions, for example the frictions of the chocks along the windows of the rolling stands. One has also suggested far more elaborate models wherein one has broken down the set of the masses and of the stiffnesses forming the rolling mill as well as the different portions liable to frictions and one has ended with more accurate representations of the possible modes of vibrations on a roll stand.

In such systems including several degrees of freedom include, several modes of vibration corresponding to several resonance frequencies.

These models have been compared with the measurement made in the roll stands while carrying out recordings during speed increases of the tandem rolling mills, particularly in the lasts stands which are most likely to vibrate. It has been noticed that the modes of vibration ranging in two bands of frequencies are particularly disturbing, because their amplitude becomes large and causes strong disturbances on the stands of the rolling mills. In comparison with the musical scale, one speaks usually of third octave frequencies for those frequencies ranging between 120 Hertz and 250 Hertz and of fifth octave frequencies for those frequencies ranging between 500 Hz and 700 Hz.

Moreover, the effects are not the same, since it has been noticed, for example, that the third octave vibrations cause thickness defects and band breakages, whereas that the fifth octave vibrations impart marks on the back-up cylinders. Additionally, depending on accurate rolling conditions, the start of the vibration phenomenon will not always take place at the same frequency, but in one of the specified ranges.

Various devices and methods have been designed for creating additional dampings on the portions vibrating, for example by changing the inlet conditions of the band in the gap (WO9627454).

Other devices disclose the use of an additional deflector roll with a variable application force so as to absorb partially the traction vibrations taking place in the band (JP 8-238510, JP 8-238511 and JP 8-238512).

The efficiency of such devices is recognised, but they exhibit the shortcoming of inserting an additional deflector roll which should be held in perfect state so as not to risk marking the band and require, further, a relatively complex control system which represents an additional constraint of implementation at each time the band is inserted in the roll stand.

Other known devices are more particularly designed for conferring an additional damping to the roll stand itself and thereby eliminating the initial vibration, or at least changing the rotational speed of the cylinders for which the phenomenon begins to take place. Document JP8-066724, for example, sets forth the installation of simple dampers between the chocks of the working cylinders, but all the sets of working cylinders must then be fitted with the device or it is necessary to disassemble and re-assemble the device at each change of cylinders that generates significant waste of time and productivity.

In order to remedy such shortcomings, it has been suggested to attach onto the upper section of the stands of the rolling mills, a general shock-absorbing means of damping including a mass of inertia, also called vibration mass, which behaves like a reference, in order to obtain system resonating on a disturbing frequency of the rolling mill, but the movements of which will be in opposite phase with the portions of the rolling mill starting to vibrate. Thus, in the patent JP 8-247211, a vibration mass is installed at the apex of each post of the stand of the rolling mill and is connected to the post by a spring leaf, the resting point of which is movable so as to be able to tune the resonance frequency. Such a device is rather easy to implement but it requires permanent tuning.

Indeed, the frequency of occurrence of the vibration phenomenon, also called chattering, is not a perfectly constant frequency. For example, assuming that the mass of the back-up cylinders is one of the components of the vibrating system, the back-up cylinders have usually a diameter ranging between 1200 mm and 1800 mm and are employed for the same installation in a diameter range of several hundred millimetres. Thus, for a nominal diameter of 1600 mm, the actual diameter of the back-up cylinders could range between 1550 mm and 1750 mm, that represents a variation of 13% of the diameter, hence of 26% the weight. But other parameters may also modify the frequency of occurrence of the chatter phenomenon, as the lubrication conditions of the gap and they may vary quite rapidly. These devices need to be tuned to the frequency of the rolling mill all the more they exhibit themselves a very sharp resonance peak.

The patent JP 09-267110 describes another damping device including a beam installed between the back-up chocks of the upper cylinders and the clamping devices of the cylinders. A central portion carries a vibration mass and is connected to both ends by spring-loaded devices also including cylinders forming dampers

In a variation, the vibration mass is integral with a kind of piston able to move in a closed chamber filled with a viscous fluid and thus forming a passive damper.

All these devices known are rather complex and exhibit several degrees of freedom, since several masses connected by different spring-loaded pieces must be taken into account. Their frequency response exhibits hence several poles of resonance and anti-resonance, the amplitude of the peaks available at these poles is significant, that confers a great efficiency to the device, but the width of the frequency band of each peak is narrow that requires a very accurate and permanent tuning on the frequency of the phenomenon seeking to be cancelled.

But the purpose of the invention is to remedy these shortcomings by a method and a device more straightforward and easier to be implemented, which exhibits an eigen band-post relatively large with respect to the possible frequency variations of the spurious phenomenon that one wishes to correct.

The invention relates therefore, generally, to a clamping method of the vibrations in a roll stand of the type including two posts between which a set of cylinders are stacked in a substantially vertical plane and mounted rotatably in chocks forming a bearing, which are mounted slidingly vertically between guiding surfaces provided along said posts, a method wherein the energy of vibrations is absorbed by at least two vibration masses connected respectively to each of the posts of the stand by an adjustable means of connection. According to the invention, each vibration mass is connected directly to the upper part of the corresponding post by an incompressible fluid mattress contained in a chamber of an hydraulic actuator limited by two elements sliding into one another, respectively a first element forming at least one portion of the vibration mass and a second element attached directly to the upper part of the post and that, during rolling, the thickness of said mattress of connection is kept permanently at a substantially constant value.

Such a method enables to reduce the chatter sensitivity of the roll stand to vibrations due to masses vibration situated above each of the posts, the vibration energy of the roll stand being absorbed by a mattress of an incompressible fluid which constitutes a direct link between the apex of each of the posts and the vibration mass associated.

A In a preferred embodiment, the incompressible fluid forming the mattress of connection is kept in permanent flow in an outer circuit connected on the chamber of the actuator, between fluid exhaust means with an adjustable flow rate and return means into said chamber.

Particularly advantageously, the exhaust flow rates of the fluid towards the outer and return circuit in the chamber of the actuator are adjusted so as to keep the thickness of the fluid mattress at a substantially constant optimum value.

In this view, according to another advantageous feature of the method of the invention, the thickness of the mattress of the fluid of connection is measured permanently by a position sensor and one acts on the fluid supply means, with a regulation loop, for adjusting the thickness of the mattress. The adjustment of the value of the thickness of the mattress enables to adjust the stiffness of the damping system to an optimum value.

Preferably, one varies the circulation flow rate of the circulating fluid feeding the mattress is modified by the adjustment exhaust means so as to adjust the value of the damping coefficient of the damping device to an optimum value.

However, it is also possible to vary the value of the vibration mass situated above each post for adjusting the value of the damping coefficient of the damping device to an optimum value.

According to another preferred feature of the invention, a combination of the thickness adjustment values of the fluid mattress, of the flow rate of the fluid feeding the mattress and of the vibration mass is selected to provide an optimum value of the stiffness and of the damping coefficient of the damping device, which enables to centre the band part of the damping device on the chatter frequency of the roll stand.

The invention also covers a chatter absorbing device in a roll stand including two posts being each associated to at least one vibration mass connected to the upper part of said post by an adjustable connection means formed of at least one mattress of an incompressible fluid contained in a chamber of at least one hydraulic actuator limited by two elements mounted glidingly into one another in a tight manner, respectively a first element forming at least one portion of the vibration mass and a second element attached to the upper part of said post, each of said actuators being associated with a means for holding permanently the thickness of said fluid mattress at substantially constant value.

In a preferred embodiment, each actuator is connected to an outer circuit for a permanent flow unit of the fluid contained in the chamber of said actuator, between an exhaust circuit of the fluid contained in the chamber of the actuator, fitted with a means of adjustment of the exhausted flow rate, and a fluid return circuit into the chamber of the actuator.

To do so, the chamber of each actuator comprises at least one fluid orifice connected to a reservoir by an exhaust circuit fitted with a means of adjustment of the exhausted flow rate and at least one inlet connected to the reservoir by a return circuit fitted with a flow rate-adjustable pump. Preferably, this flow rate is regulated from a measurement, by a sensor, of the thickness of the fluid mattress in the chamber of the actuator, for holding said thickness at a substantially constant value.

In a preferred embodiment, the fluid used for making the fluid mattress is oil whereof the viscosity of which is greater than 50 centistokes.

Other advantageous features of the invention will appear in the following description of a particular embodiment illustrated by the appended drawings.

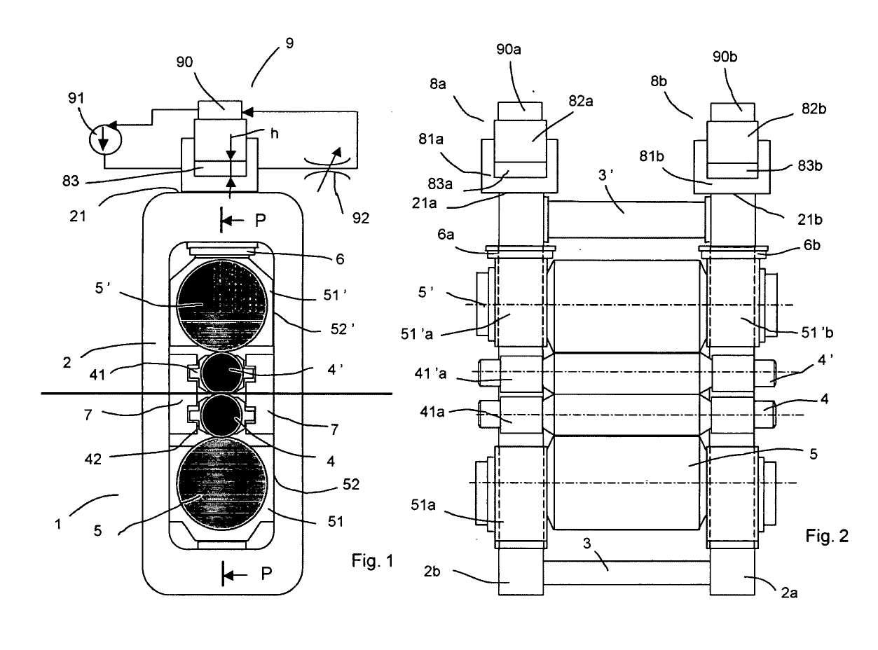

FIG. 1 represents an elevation view of a roll stand view, which a device according to the invention is represented schematical;

FIG. 2 represents a side view of FIG. 1;

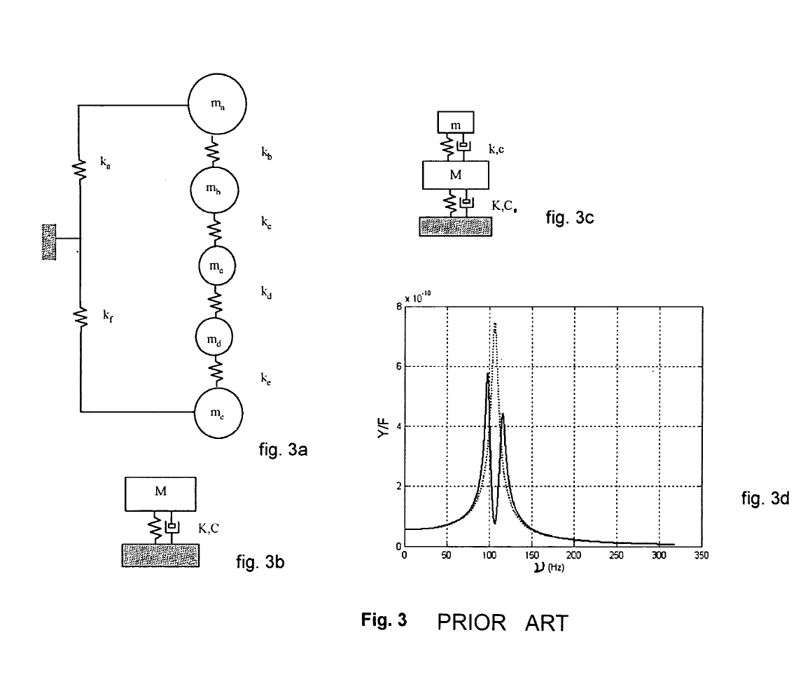

FIG. 3 shows the model and the frequency response of the devices of the prior art.

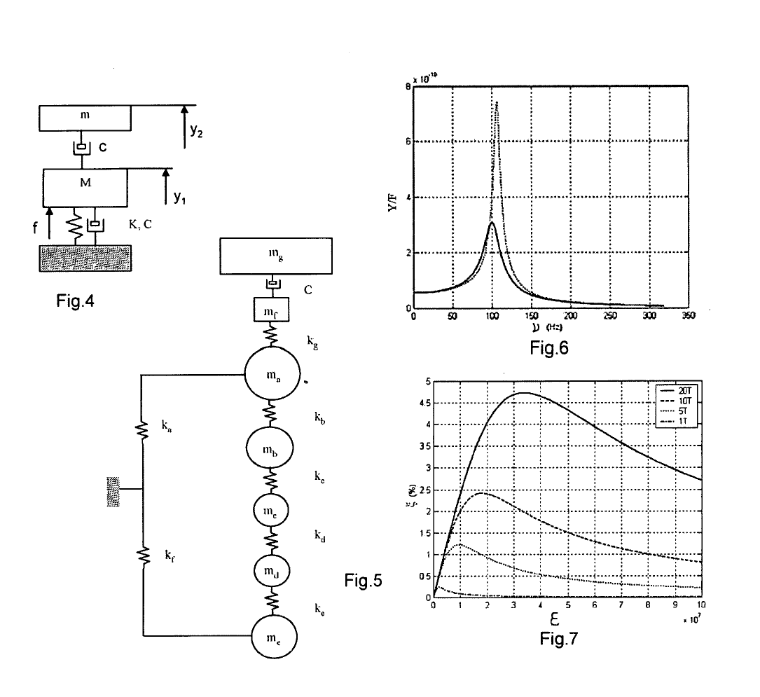

FIG. 4 represents a simplified model of the device according to the invention.

FIG. 5 represents another model of the device according to the invention.

FIG. 6 represents the frequency response of the device of the invention.

FIG. 7 represents the adjustment characteristic curve of the method of the invention.

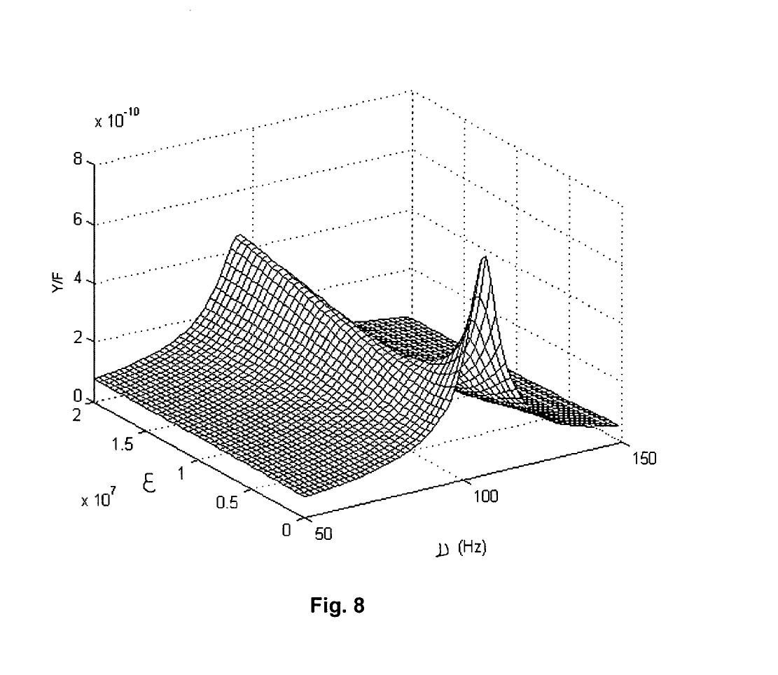

FIG. 8 represents, as a surface, the set of the characteristics of the method of the invention.

As represented on FIGS. 1 and 2 a roll stand 1 comprises two supporting columns 2,2′ spaced apart and connected by cross-beams 3,3′, between which a set of cylinders are stacked with parallel axes, placed substantially in the same clamping plane substantially perpendicular to the displacement direction of movement of the product.

One may configure rolling mills of different types. Generally speaking, in a rolling mill, the product to be rolled passes between two working cylinders 4,4′ which define the rolling plane, these cylinders are usually of relatively small diameter with respect to the loads to which they are subjected. Hence, they generally rest respectively on at least two back-up cylinders 5,5′ between which the rolling load is applied.

The so-called ‘quarto’-type rolling mills comprise therefore four stacked cylinders, respectively two working cylinders associated, respectively, with two back-up cylinders of larger diameters.

In the ‘sexto’-type rolling mills, intermediate cylinders are interposed between each working cylinder and the corresponding back-up cylinder.

Other types of rolling mill, including many or few cylinders are known and used in the industry.

The cylinders rest on one another along bearing lines substantially parallel, and directed along a generatrix, whereof the profile of which, normally rectilinear, depends on the loads applied and on the resistance of the cylinders. Generally the clamping load is applied by screws or jacks 6a, 6b interposed between the stand and the ends of the shaft of the upper back-up cylinder 5′, the lower back-up cylinder 5′ resting by its ends directly on the stand. Apart from the lower back-up cylinder, the other cylinders should therefore be able to move relative to the stand and, in this view, are carried by supporting members 51, 51′ mounted slidingly vertically in two windows provided in the two columns of the stand.

Means of clamping such as screws or jacks 6a, 6b, resting on the stand, apply a vertical load in a direction for bringing of the cylinders nearer in order to roll the product B passing between the working cylinders.

Generally, each cylinder is mounted rotatably, around its axis, on bearings carried by two support members called chocks 41, 41′. These chocks are mounted slidingly, parallel to the clamping plane P running through the axis of the working cylinders, each chock between two planar guiding faces provided respectively on both sides of said clamping plane, on both sides of the corresponding window of the stand. As the back-up cylinders have a large diameter, the corresponding guiding faces 52, 52′ are generally provided directly on both posts of the corresponding column of the stand. Conversely, the working cylinders having a smaller diameter, their chocks are smaller and the corresponding guiding faces 42, 42′, which are more narrow, are provided, generally, on two massive part 7 fixed to both posts surrounding the window and protruding towards the inside thereof. These massive parts or blocks may comprise devices for controlling the bending of the working cylinders, generally jacks, not represented on the figure. It is not necessary to describe further all these devices well-known in the rolling stands, which have been the subject matter of numerous publications.

The so-called chatter phenomenon has been studied for a long time. As indicated above, different means have been suggested for damping said vibrations which may be modelled.

Conventionally, the analysis of the vibrating behaviour and of the relative movements of the different sections of the stand with respect to one another, for roll stand including clamping jacks provided at the upper section of both posts of the stand, leads to models composed of masses of inertia and of stiffnesses which may be schematised as indicated on FIG. 3a, wherein:
mₐ is the mass of the upper sections of both columns 2, 2′
m_{b is} the mass of both upper back-up chocks 51a′ and 51b′.
m_{c} is the mass of the upper equipment including the upper working cylinder 4′ and its chocks 41a′ and 41b′ and the upper back-up cylinder 5′, respectively m_{d} is the mass of the lower equipment.
mₑ is the mass of the bottom sections of both columns 2, 2′ and of the lower back-up chocks 51a to 51b.
k_{a is} the stiffness of the top sections of both columns 2, 2′.
k_{b} is the hydraulic stiffness of the clamping jacks 6a, 6b considered for an average oil fill-up.
k_{c} is the stiffness of the link between the upper bearing chock 51a′, 51b′ and the upper back-up cylinder 5′.
k_{d} is the stiffness caused by the flattening of the cylinders and the stiffness cause by the sheet of metal.
kₑ is the stiffness of the link between the lower bearing chock 51a, 51b and the lower back-up cylinder 5.
k_{f} is the stiffness of the bottom sections of both columns 2 and 2′.

A roll stand may thus be modelled rather accurately when one wishes to study the influence of the various components on the chatter phenomenon. But one may also simplify the calculations by keeping only a modelling of the type represented on FIG. 3b. Such a modelling is generally speaking sufficient to study the effect of an external damper C added to a roll stand, in order to try to remedy the chatter problems. The values of M, K and C are then defined by combination of all the masses of inertia and of the stiffnesses according to the laws well-knowed of the mechanics of vibrations for series and parallel assembly of resonators.

FIG. 3c shows the modelling of a damping device of a type known in the previous art, including a mass of inertia m, also called vibration mass, connected to the roll stand of mass M and stiffness K by a spring-loaded system k and a viscous damper c.

FIG. 3d is a diagram showing the frequency response of such a system with, in abscissa, the frequency ν of the excitating force indicated in Hertz and, in ordinate, the transfer function Y/F as indicated below. The dotted line curve shows the response of the stand alone and the full line curve shows the response of the damping system schematised on FIG. 3c.

It appears that the response of such a system with several degrees of freedom comprises at least two poles. The attenuation may be strong but it requires tuning the damping device on the frequency of the phenomenon to be attenuated since the band-pass of each pole is narrow. The stiffer the device suggested, the more poles there will be and the more necessary it will be to tune the correct resonance of the device with the frequency of occurrence of the chatter phenomenon on the roll stand.

In the method of the invention, the operations of which is schematised on FIGS. 4, 5, 6, 7, a link is provided between the chatter mass 8 and the upper section 21 of the posts 2. This link does not comprise any stiff link, or at least its stiffness is infinitely great and is realised by a mattress 83 of an incompressible and viscous fluid. The assembly of the device 9 of the invention is represented on FIGS. 1 and 2. The roll stand 1 is of a conventional type described above. The stanchions 2 and 2′ form a roll stand, wherein a plurality of cylinders is arranged substantially in a same plane P which is substantially vertical. A pair of cylinders of relatively small diameter 4, 4′ constitutes the working cylinders in direct contact with the product B. They are mounted rotatably in bearings 41, 41′ which are also called chocks and may slide vertically in a slot provided in the stanchions. In a manner generally known, these chocks are guided in hydraulic blocks 7 which are installed in the windows of the columns 2, 2′ and provide means for cambering the working cylinders.

The working cylinders bear against the back-up cylinders 5, 5′, which are also mounted rotatably in bearings or chocks 51a, 51b, 51′a, 51′b capable of sliding vertically in the windows provided in the stanchions 2, 2′. The force necessary for the reduction in thickness of the product B is provided for example by hydraulic clamping jacks 6a, 6b which are installed for example in the upper section of the stanchions 2, 2′. They exert their load on the ends of the upper back-up cylinder 5′ through the bearings 51′a, 51′b. On the other side, the lower back-up cylinder is blocked vertically at the bottom of the stand by its bearings 51a, 51b which directly rest on the bottom of the slot arranged in the stanchions 2, 2′.

According to the invention, a structure 8a, 8b capable of receiving at least one chatter mass 82a, 82b is installed on each apex 21, 21′ of the stanchions 2, 2′.

The structure 8a, 8b may advantageously have a hollow shape 81a, 81b to form the cylinder of an hydraulic jack, and the chatter masses may comprise a protruding end forming the piston of this hydraulic jack. The cavity formed inside this jack is filled with an incompressible fluid forming the mattress 83 which ensures a flexible link between the apex 21 of the stanchions of the roll stand and the chatter mass 8 intended for absorbing the shocks thereof.

Generally speaking, the oil-type dampers have well-known embodiments such as, for example, in the automotive field. To provide the damping effect, the oil is compressed in a jack chamber and generally speaking may flow out of a calibrated orifice which limits the outflow speed of the fluid due to its viscosity. This calibrated orifice is also called a throttling or a flow regulating valve.

A restoring device is then needed to bring the damper back to its initial state by pumping the fluid in the chamber where it was situated at the beginning of the cycle and thus find again a damping capacity. Moreover, after a certain operating time or after a number of operating cycles, the damper is not in a position to perform its function any longer. Indeed the ageing of the oil reserve, or the diminution, let alone the loss, of this reserve due to leaks of the device render it inefficient. The restoring device is generally speaking a spring which exhibits the shortcoming of introducing a stiffness in parallel with the damper itself, and hence, as already said, of introducing several degrees of freedom, and, consequently, poles into the frequency response requiring an accurate tuning

To remedy this shortcoming, in a device according to the invention, the oil mattress 83 is held permanently in circulation by a pump 91. A reservoir 90 may be advantageously installed on the chatter mass 82. The oil circulates under the action of the pump 91. It is introduced into the jack chamber using appropriate pipes through orifices drilled in the body of the jack formed by the structure 81 or, according to the commodities of the practical realisation, drilled through the section forming the body of the jack 82. An exhaust duct is realised similarly and the oil returns to the reservoir by flowing through an orifice of adjustable gauge 92 which constitutes the throttling. Such a device is hence held permanently in an operating position and its features do not evolve with time, the oil being renewed permanently and the reservoir being of sufficient capacity with respect to the quantity of fluid necessary for keeping the fluid mattress of height h. According to an essential disposition of the invention, the thickness h of the fluid mattress 83 is measured by an appropriate sensor, or its level is detected so as to control the pump for holding the level substantially constant. The chatter energy absorbed is dissipated by the fluid in the throttling as well as a portion of the permanent power used for the circulation of the fluid in the whole circuitry. It is hence desirable to provide on the oil circulation system a cooling device so as to prevent excessive temperature rise of the fluid. Such devices may be installed in series in the fluid circuit or be mounted as a branch-off, but they are well-known to the man of the art and it is therefore not necessary to describe it any further.

In the device of the invention and according to the requirements of shock absorption of the roll stand considered, it is hence possible to arrange a chatter mass 82 of a more or less large value in the structure 8. Similarly, according to the requirements, the height h will be more or less significant for the fluid mattress 83.

It is also advantageous, and in order to obtain the optimum shock-absorption, to adjust the throttling which enables to vary the energy absorbed, or to use a fluid of adapted viscosity, for example an oil the flow features of which will be chosen to suit the requirements. All these parameters constitute means to determine or to adjust performances of the damping device.

Modelling of such a device is represented on FIGS. 4 and 5.

FIG. 4 illustrates a diagram with a single degree of freedom. It enables to determine the global behaviour of the system and to size the chatter masses to be installed, the flow rates to be provided as well as the pumps. FIG. 5 illustrates a more accurate modelling which picks up the modelling of the roll stand already described previously.

A damping device composed of a mass m and linked with the stand by a viscous damper c is added and the mass m_{f} of the support and the stiffness k_{g} of the link therewith are taken into account. In the device of the invention the chatter mass is linked directly to the roll stand by the fluid mattress.

But the compression of a fluid is given by the relation:

$$\frac{Δ V}{V} = {χ}_{T} Δ P$$

This relation shows that the volume relative variation is linked with pressure variation by the isothermal compressibility: χ_{T}. Now in an embodiment as described, it is possible to operate using a low hydraulic pressure, of the order of few bars. The possible pressure variation will as well be low and the fluid may then be considered as incompressible, which enables to consider the stiffness k_{g} of the link as infinite.

Besides, the fluid used in the method of the invention should be viscous, it is indeed the flow through the throttling which will dissipate the energy of inadvertent vibrations.

One may hence select a damping coefficient ε of the damping device by the appropriate choice of fluid, and in particular the choice of the oil and of its viscosity.

The cinematic viscosity intervenes in the theoretical calculations and the model. It is usually expressed in the international units in m²/s but it is conventional to use a sub-multiple of this magnitude which is the centistokes (10⁶ centistokes=1 m²/s). In the method of the invention, the use of oils having a viscosity at least equal to 50 centistokes has been considered. The choice of oils enables to vary this magnitude up to several hundreds of centistokes, and the more so because such magnitude depends on the temperature, which also gives an additional means to make it vary, hence to adjust the parameters of the damping method.

A damping method of a roll stand according to the invention exhibits characteristics which are quite different from those of the conventional systems and they are illustrated by the representations of FIGS. 6, 7 and 8. It is usual to find the equation of the behaviour of a system with a single degree of freedom, as represented on FIG. 4 by calculating the frequency response of the system to be damped and the frequency of the response system to which the damping device has been added, as well as the damping coefficient of the assembly. To do so, the ordinate of the free end of the device capable of starting to vibrate inadvertently relative to an absolute location is marked y₁, i.e. with respect to a point of said device which will remain without any movement during the phenomenon. In the framework of the invention y₁ refers to a point of the top of the columns 21 of the roll stand 1 relative to a point of the lower section linked to the foundations. Similarly, y₂ refers to the ordinate of a point of the chatter mass 82a, 82b of the damping device 9. Let f be any excitation force exerted on the mass of the system that ought to be shock-absorbed, i.e. the roll stand 1. The equation is drawn up conventionally by writing the equilibrium of an isolated system and by considering, on the one hand, the roll stand 1, and on the other hand, an assembly formed of the roll stand and of its damping device 9. In both cases the transfer function is

$$T = \frac{Y}{F} ,$$

Y and F being respectively the Laplace transform of the displacement y₁ of a point of the system and of the impulse force f.

The frequency response is represented on FIG. 6. On that Figure one can see a characteristic of the method of the invention by comparing its shape to that of the frequency response of the devices according to the previous art represented on FIG. 3d.

For a same resonance amplitude of the device to be damped, the frequency response of the damping device exhibits an amplitude lower than that of the known devices, but it has advantageously a single pole since, as indicated above, a device according to the invention does not introduce any additional stiffness.

It appears that the band-pass of the device of the invention is widened relative to that of the known devices that implies that it is not necessary to tune the device the frequency of the disturbing phenomenon. Said band-pass is indeed wider than the spectrum of the frequencies according to which the chatter phenomenon takes place. The different components of the damping device according to the invention should be sized so as to provide a sufficient efficiency relative to the masses and to the stiffnesses forming the device to be clamped. The theoretical study shows that the shock-absorption amplitude of the damping, as well as the width of the covered spectrum are higher, all the more so because the chatter mass m is significant. In practice, it is obviously necessary to be able to install the shock-absorption masses 82a, 82b, in their supporting structures 81a, 81b as well as the whole device 9.

Another important advantage of the invention is the easiness of this device 9.

Indeed, it is situated at the top of the stand, attached to the apexes 21a, 21b of the posts 2a and 2b at a location where generally speaking space is available on a roll stand.

It may be installed permanently since this zone is never affected by the operational use of the rolling mill and does not involve any disassembly or re-assembly during the different operation phases. However, the space is limited to the room available at the apex of the columns 2a, 2b and it may be necessary to optimise all the parameters. The proportioning of the chatter masses installed in the supporting structures 81a, 81b will enable to centre the action spectrum of the clamping device on the frequency band of the zone where the unwanted chatter phenomenon occurs.

Generally, the study the transfer function, represented by Y/F, enables to perform such optimisation. One may extract from this function the damping ratio ξ which is the damping of the whole system. This ratio is a dimensionless quantity, the value of which ranges between 0 and 1. A value close to 0 represents an oscillating system and a value close to 1 represents a system completely damped which will have a response to a force impulse without any oscillation. The ratio ξ is a function of the characteristics of the device to be damped, and also of the characteristics of the damping device itself. In particular, in the method of the invention, this ratio, which gives the value of the performance of the system, depends on the values of the chatter mass 82a, 82b, of the damping coefficient ε, which is the damping provided by the damping device, defined by the throttling 92 and the viscosity of the oil used, and of the height h of the oil mattress.

ξ=f(m,ε,h)

The variations of this damping ratio are represented on FIG. 7. The shape of these curves are a feature of the method of the invention. It is in particular due to the fact that no additional stiffness has been introduced thanks to the use of the oil mattress in circulation the level of which is regulated as a direct link member of the chatter mass with the device to be damped.

As indicated previously, an optimum height of the oil mattress may be defined corresponding to the stiffnessly of the damping system enabling to damping the vibrations of the stand as far as possible. In any case, this stiffness will be very high, all the more if low pressure oil is used, but the adjustment of the height of the oil mattress enables to have a certain adjustment range.

The curves of FIG. 7 have been drawn for different values of the chatter mass and represent the damping ratio ξ of the whole roll stand relative to the own damping coefficient ε provided by the method of the invention. It appears that there is an optimum value of ε to a have system damped as far as possible. According to the value of the chatter mass installed and the nature of the viscous fluid selected, as well as the optimum value h of the thickness of the fluid mattress in circulation, the throttling 92 may then be adjusted to have the value requested for the damping ratio ξ and this will condition the flow rate to be provided by the pump 91.

Another representation of the characteristics of the method of the invention is provided on FIG. 8 in three dimensions. The surface represents, for a determined chatter mass, the transfer function T=Y/F relative to the frequency ν of the excitation force f and of the damping coefficient ε. This representation puts in evidence an optimum adjustment for band of frequencies centred on the frequency zone of the chatter.

The whole device of the invention may be adjusted once for all during its implementation. It is an advantage of the method of the invention since it does not require any setting nor adjustment during the operation of the rolling installation. It does not require to be tuned after changing the working cylinders or the back-up cylinders.

In practice, the theoretical studies and the experiments of the applicant have shown that the installation of a 5-ton chatter mass at the top of each column enables to obtain very good results. This installation on a device of the hydraulic jack type enables to operate at a pressure of the order of 2 bars and the necessary power of the pump is of the order of 1 kW.

Thus for a roll stand, whereof the global damping ratio ξ of which has a value of the order of 4%, the method of the invention enables to increase the global ratio from 1.5% to 2% to around 6%. In other words, the method according to the invention enables to increase by 50% the value of the damping ratio of a roll stand.

In practice, if we consider a tandem rolling mill for which the typical speed at which the chatter phenomenon occurs is 1400 m/min, the device of the invention will enable to increase this speed by a value which may reach 240 m/min. It is therefore a direct increase in the productivity of the installation by 17% which may thus be obtained by the method of the invention.

But the invention is not limited to the single embodiment described. Thus the flow of the fluid feeding the mattress 83 with oil may take place in different ways and the throttling 92 may be arranged on an orifice of one of the sections forming the jacks 82, 83 or on the pipework. Similarly, the regulation of the height h of the mattress 83 may be conducted in different ways, using a position sensor of a pump with variable flow rate or using level detectors and a conjunction/disjunction device while remaining in the domain of the invention.

The realisation of the device enabling to form the oil mattress in a tight cabinet may also lead to all the possible variations without departing from the framework of the invention.

Similarly, the reference signs inserted after the technical characteristics mentioned in the claims, solely aim at facilitating the understanding thereof and do not limit the scope thereof in any ways.

1. An active method for absorbing the vibrations in a roll stand (1) of the type including two posts (2a, 2b) between which a set of cylinders (4,5) are stacked up in a substantially vertical plane (P) and mounted rotatably in chocks (41, 51) forming a bearing, which are mounted slidingly vertically between guiding surfaces (52) provided along said posts, a method wherein the energy of vibrations is absorbed by at least two chatter masses connected respectively to each of the posts of the stand, by an adjustable means for linking, characterised in that each chatter mass is connected directly to the upper part of the corresponding post by an incompressible fluid mattress contained in a chamber of a hydraulic actuator limited by two elements sliding into each another, respectively a first element forming at least one portion of the chatter mass and a second element attached directly to the upper part of the post and in that, during rolling, the thickness of said linking mattress is kept permanently at a substantially constant value.

2. A method according to claim 1, characterised in that the incompressible fluid forming the linking mattress is kept in a steady flow in an outer circuit connected on the chamber of the actuator, between fluid exhaust means with an adjustable flow rate and return means into said chamber.

3. A method according to claim 1, characterised in that the exhaust flow rates of the fluid towards the outer and return circuit in the chamber of the actuator are adjusted so as to keep the thickness of the fluid mattress at a substantially constant optimum value.

4. A method according to claim 3, characterised in that a position sensor mounted on the chatter mass (82a, 82b) gives the thickness (h) of the linking fluid mattress (83) permanently.

5. A method according to claim 4, characterised in that the thickness (h) of the fluid mattress (83) is adjusted using the indication of the position sensor, the fluid supply means (91), and using a regulation feedback loop.

6. A method according to claim 1, characterised in that the thickness (h) of the fluid mattress (83) is adjusted so as to adjust the stiffness value of the damping system to an optimum value.

7. A method according to claim 2, characterised in that the fluid flow rate adjustment of the fluid mattress (83) using the exhaust means (92) of adjustable caliber enables to determine a damping coefficient of the damping device (9) which has an optimum value.

8. A method according to claim 2, characterised in that the value of the chatter mass (82a, 82b) situated above each post (2a, 2b) is adjusted so as to determine a damping coefficient of the damping device (9) which has an optimum value.

9. A method according to claim 2, characterised in that one selects a combination of the adjustment values of the thickness (h) of the fluid mattress (83), of the flow rate of the fluid feeding said mattress, and of the value of the chatter mass (82a, 82b) situated above each post, said combination providing an optimum value of the stiffness and of the damping coefficient of the damping device (9), enabling to centre the band-pass of said damping device (9) on the chatter frequency of vibration of the roll stand (1).

10. A vibration absorbing device in a roll stand (1) including a set of stacked cylinders (4,5), with parallel axes, in a substantially vertical plane and mounted rotatably, at their ends, each on two chocks forming a bearing, mounted slidingly between guiding surfaces provided along two posts of the stand, each post being associated with a chatter mass connected to an upper portion of said post, by an adjustable means for linking, characterised in that the means for linking each chatter mass with the corresponding post is formed of at least one mattress of incompressible fluid contained in a chamber of at least one hydraulic actuator limited by two elements mounted tightly and slidingly into one another, respectively a first element forming at least one portion of the chatter mass and a second element attached to the upper part of said post, and that each of said actuator is associated with a means for holding permanently the thickness of said fluid mattress at a substantially constant value.

11. A device according to claim 10, characterised in that each actuator is connected on an outer unit for the steady flowing of the fluid contained in the chamber of said actuator, between an exhaust circuit of the fluid contained in the chamber of the actuator, fitted with an adjustment means of the exhausted flow rate, and a fluid return circuit in the chamber of the actuator.

12. A device according to claim 11, characterised in that the fluid exhaust circuit is fitted with an orifice of adjustable gauge forming a throttling (92) for adjusting the flow speed of the fluid in said exhaust circuit.

13. A device according to claim 11, characterised in that the chamber of each hydraulic actuator mounted on the upper section of a corresponding post of the stand comprises at least one fluid outlet connected to a reservoir by an exhaust circuit fitted with an adjustment means of the exhausted flow rate and at least one inlet connected to the reservoir by a return circuit fitted with a flow rate-adjustable pump.

14. A device according to claim 12, characterised in that the flow rate of the fluid return pump is regulated with a measurement, by a sensor, of the thickness of the fluid mattress in the chamber of the actuator, for holding said thickness at a substantially constant value.

15. A damping device of a roll stand (1) according to claim 10, characterised in that the fluid used is oil having a viscosity greater than 50 centistokes.

16. A method according to claim 3, characterised in that the fluid flow rate adjustment of the fluid mattress (83) using the exhaust means (92) of adjustable caliber enables to determine a damping coefficient of the damping device (9) which has an optimum value.

17. A method according to claim 3, characterised in that one selects a combination of the adjustment values of the thickness (h) of the fluid mattress (83), of the flow rate of the fluid feeding said mattress, and of the value of the chatter mass (82a, 82b) situated above each post, said combination providing an optimum value of the stiffness and of the damping coefficient of the damping device (9), enabling to centre the band-pass of said damping device (9) on the chatter frequency of vibration of the roll stand (1).
